(19) United States
(12) Patent Application Publication
(10) Pub. No.: US 2019/0184799 A1
(43) Pub. Date: Jun. 20, 2019

(54) VEHICLE TAILGATE STRUCTURE

(71) Applicant: TOYOTA MOTOR EUROPE, Brussels (BE)

(72) Inventors: Martin KERSCHBAUM, Brussels (BE); Julien TACHON, Brussels (BE); Takashi KUROSE, Brussels (BE); Frank ANNA, Blieskastel (DE); Thomas MÜLLER, Hermersberg (DE)

(73) Assignee: TOYOTA MOTOR EUROPE, Brussels (BE)

(21) Appl. No.: 16/326,559

(22) PCT Filed: Dec. 13, 2016
(86) PCT No.: PCT/EP2016/080839

§ 371 Date: Feb. 19, 2019

(51) Int. Cl. B60J 5/10; B29C 45/14

(52) U.S. Cl. CPC B60J 5/107; B29L 2031/3014; B29C 45/14065; B29C 45/14336

(57) ABSTRACT

A vehicle tailgate structure including a first panel portion including a composite material and a second panel portion overmolded onto the first panel portion, the first and second panel portions forming together a body portion, a transverse beam and side beams connecting the transverse beam to the body portion, wherein the transverse beam includes a hinge attachment portion configured to receive a hinge attachment part, wherein the first panel portion has a bent strip in the transverse beam, and wherein the bent strip is raised with respect to a remaining portion of the first panel portion.

### TECHNICAL FIELD

The present disclosure relates to a gate structure for a vehicle, and more particularly to a vehicle tailgate structure.

### TECHNOLOGICAL BACKGROUND

Reinforced gate structures are known in the art. For instance, the publication US 2012/0280533 A1 discloses a tailgate comprising a main carrying structure consisting of a fiber-reinforced molding compound with at least two impregnated, integrated continuous-fiber bands.

However, the proposed arrangements of the bands do not enable an optimal distribution of the stresses throughout the main carrying structure. Thus, there is a need for a tailgate structure that is stiffer and yet at least as light and simply and inexpensively manufacturable.

### SUMMARY OF THE INVENTION

In this respect, the present disclosure relates to a vehicle tailgate structure comprising a first panel portion comprising a composite material and a second panel portion overmolded onto the first panel portion, the first and second panel portions forming together a body portion, a transverse beam and side beams connecting the transverse beam to the body portion, wherein the transverse beam comprises a hinge attachment portion configured to receive a hinge attachment part, wherein the first panel portion has a bent strip in the transverse beam, and wherein the bent strip is raised with respect to a remaining portion of the first panel portion.

The first and second panel portions form together a body portion, a transverse beam and side beams connecting the transverse beam to the body portion. The body portion, the transverse beam and the side beams form the conventional shape of a vehicle tailgate structure. In a vehicle up-down direction, the body portion may be a lower part of the tailgate structure and the transverse beam may be an upper part of the tailgate structure.

The bent strip of the first panel portion is a strip that may be bent and raised continuously, integrally, with respect to a remaining portion of the first panel portion. Thus, there is a non-zero angle between the raised portion and the remaining portion of the first panel portion. The remaining portion may be a portion of the first panel portion adjacent to the bent strip. The bent strip may be provided at an edge of the first panel portion.

Since the bent strip of the first panel portion is provided in the transverse beam, which comprises a hinge attachment portion where high stresses may occur, the bent strip increases the stiffness of the first panel portion in an area of high stresses. Therefore, a high stiffness of the vehicle tailgate structure is achieved, without increasing the weight of the vehicle tailgate structure. Moreover, the bent strip enables a good and simple positioning of the first panel portion in the mold for overmolding the second panel portion, which lowers manufacturing costs.

In certain embodiments, the second panel portion has a bead supporting the bent strip. The bead may support all or part of the bent strip, in particular a non-planar region of the bent strip. The bead of the second panel portion is a local angled elevation or dent of the second panel portion itself. Since the second panel portion having the bead is formed by overmolding onto the first panel portion, the shape of the mold, which is configured to form the bead, also supports the first panel portion. Therefore, forming of the first panel portion inside the mold is made easy. Besides, the mold may be devoid of undercuts, which ensures that the second panel portion does not comprise any excessively enlarged area having higher risks of containing molding defects, and guarantees easy demolding of the vehicle tailgate structure.

In certain embodiments, the bent strip at least partly surrounds the hinge attachment portion. Therefore, the bent strip increases stiffness at the very location of the stresses brought into the vehicle tailgate structure by the hinge attachment part.

In certain embodiments, the bent strip is provided at least on opposite sides of the hinge attachment portion. The stresses brought by the hinge attachment part are thus better distributed in the first panel portion.

In certain embodiments, a bending angle of the bent strip is less than 90°, preferably less than 80°, preferably less than 70°, preferably less than 60°. The bending angle of the bent strip is the angle by which the bent strip is bent with respect to its non-bent position, that is, the angle between the bent strip and the imaginary position of the bent strip if it were aligned with an adjacent portion of the first panel portion.

In certain embodiments, the bead protrudes towards the first panel portion. This further eases the overmolding of the second panel portion onto the first panel portion.

In certain embodiments, the bent strip extends to at least one of the side beams. Thus, the bent strip enhances a load transfer from the transverse beam to the one of the side beams.

In certain embodiments, the hinge attachment portion extends in the first panel portion. This feature increases stiffness of the vehicle tailgate structure directly in an area of high stresses. Stresses introduced by the hinge attachment portion are directly taken over by the composite material of the first panel portion.

In certain embodiments, the hinge attachment portion extends in the second panel portion.

In certain embodiments, the composite material comprises continuous fibers embedded in a matrix. The fibers act as a reinforcement of the composite material. As known in the art, so-called “continuous fibers” may not actually be “continuous” in the strictest definition of the word. However, they are longer than so-called “long fibers” and may extend from about a decimeter to a few dozen meters. Such fibers are called continuous because the length of the fibers tends to be orders of magnitude larger than the diameter of the fibers. As will be seen by the examples later described, the arrangement of the continuous fibers in the first panel portion is not limited to a particular pattern.

The continuous fiber-reinforced material may be obtained from an impregnated preform of continuous fibers, or from an organo-sheet.

In certain embodiments, an arrangement of the continuous fibers is quasi-isotropic. In general, fiber reinforcements may be unidirectional (UD), which means that the fibers are all substantially aligned along the same direction. Fiber reinforcements may also be bidirectional (2-D), which means that fibers are substantially aligned on a plane surface, along two main directions. By contrast to unidirectional and bidirectional, quasi-isotropic patterns are such that fibers are oriented in at least three directions, preferably substantially regularly distributed. For instance, in a two-dimensional ply or a set of superimposed two-dimensional plies, the fibers of all plies taken together, preferably of each ply, are oriented in at least three directions. In other words, the continuous fiber reinforcement may consist of several plies and each ply can have a unidirectional fiber orientation or a multi-directional fiber orientation. The multi-directional fiber orientation may be a woven reinforcement having warp and weft yarns oriented in an angle of 90° to each other. Any specific layup pattern and combinations of plies with unidirectional or multidirectional fiber orientations is suitable, including 0/60/−60, which corresponds to three directions having an angle of 60° with one another, 0/90/45/−45, which corresponds to four directions having an angle of 45° with one another, or the like. The pattern 0/90/45/−45 may also be obtained by stacking identical 0/90 plies rotated by 45° with one another. The same proportion, substantially, or different proportions of the fibers may be oriented in each direction. For instance, substantially 25% of the fibers may be oriented in each of the 0/90/45/−45 direction. Any quasi-isotropic pattern is possible depending on the desired mechanical properties. Apart from a quasi-isotropic pattern, any specific combination of individual ply angles and individual ply thicknesses is possible in order to obtain the best performance of the first panel portion in terms of stiffness, weight and manufacturability. In addition, the reinforcement may have more plies in certain regions which act as a local additional reinforcement in especially high stressed areas.

In certain embodiments, the vehicle tailgate structure further comprises at least one stiffening rib overmolded on the first panel portion, on a side of the first panel portion opposite the second panel portion. The first panel portion is sandwiched between the second panel portion and the stiffening rib. This further increases the stiffness of the tailgate structure.

In certain embodiments, some of, preferably most of, preferably each of the at least one stiffening rib has at least one end thereof directly connected to the second panel portion. In other words, some of, preferably most of, preferably each of the at least one stiffening rib is part of the molded material of the second panel portion, i.e. integrally molded with the second panel portion. Furthermore, since at least one end thereof is directly connected to the second panel portion, the molding flow paths of the stiffening ribs are shorter, which contributes to complete filling of the ribs by the molding material and reduced shrinkage in the ribs. The overmolding process is thus improved, as well as the quality of the ribs, hence the better stiffness of the tailgate structure. In certain embodiments, those of the stiffening ribs that have at least one end thereof directly connected to the second panel portion may be regularly distributed and/or spaced from on another by a predetermined distance or less, e.g. 10 cm (centimeters) or less.

In certain embodiments, the second panel portion completely covers a side of the first panel portion. Since the overmolded second panel portion can be given a high-quality surface, completely covering a side of the first panel portion makes it possible to use the second panel portion as a vehicle inside surface of the tailgate structure. This eliminates the need for an inner trim, thus making the final tailgate lighter and cheaper.

In certain embodiments, the second panel portion comprises an injection gate mark in at least one of the hinge attachment portion and an actuator attachment portion. The actuator may be e.g. a gas spring or an electrically powered actuator. Since the hinge attachment portion and the actuator attachment portion will be hidden respectively by the hinge attachment part and an actuator attachment part, locating injection ports (or gates) in front of at least one of these portions enables to obtain a high surface quality and not disturb the surface appearance of the second panel portion with injection marks, which would otherwise require further machining operations to be removed. Accordingly, the cost of the manufacturing process is reduced.

The present disclosure is also directed to a vehicle tailgate comprising the vehicle tailgate structure as previously described, and a vehicle comprising the vehicle tailgate structure as previously described.

The present disclosure is also directed to a method of manufacturing a vehicle tailgate structure, comprising:

providing a mold having a cavity comprising a body portion forming portion for forming a body portion, a transverse beam forming portion for forming a transverse beam, and side beam forming portions for forming side beams configured to connect the transverse beam to the body portion, wherein the transverse beam forming portion is configured to form a hinge attachment portion configured to receive a hinge attachment part;

inserting a first panel portion, comprising a composite material, into the cavity;

forming a bent strip in the first panel portion, wherein the bent strip is raised with respect to a remaining portion of the first panel portion;

overmolding a second panel portion onto the first panel portion.

This method may result in the vehicle tailgate structure having some or all of the features previously described.

In certain embodiments, the mold comprises at least one injection gate opening out in a portion of the cavity configured to form a hinge attachment portion or an actuator attachment portion. As previously explained, this enables hiding injection gates marks without requiring subsequent machining operation.

In certain embodiments, the inserting comprises setting up the first panel portion on a wall of the cavity opposite an injection gate of the mold. The injection gate may be the injection gate mentioned previously or another injection gate. Thanks to this feature, during the overmolding, the injected material exerts pressure onto the first panel portion, thus pushing the first panel against the opposite wall of the cavity. This improves the filling of the cavity and avoids defects in the second panel portion.

### BRIEF DESCRIPTION OF THE DRAWINGS

The invention and advantages thereof will be better understood upon reading the detailed description which follows, of embodiments of the invention given as non-limiting examples. This description refers to the appended drawings, wherein:

FIG. 1 is a perspective view of a simplified car;

FIG. 2 is a perspective rear view of a vehicle tailgate structure according to an embodiment;

FIG. 3 is a perspective detail view of the vehicle tailgate structure of FIG. 2;

FIG. 4 is a plane front view of the vehicle tailgate structure of FIG. 2, in direction IV of FIG. 2;

FIG. 5 is a perspective view partly showing the cross-section of the vehicle tailgate structure of FIG. 2 along plane V-V;

FIG. 6 is a perspective view partly showing the cross-section of the vehicle tailgate structure of FIG. 2 along plane VI-VI;

FIG. 7 is a simplified cross-sectional view of an overmolding step.

### DETAILED DESCRIPTION OF EMBODIMENTS

FIG. 1 shows a perspective view of a simplified car 100 comprising a tailgate 110. The tailgate 110 comprises a vehicle tailgate structure 10 according to an embodiment which will be described later. For clarity's sake, the present description refers to the tailgate 110 of a car 100, but the principles herein described could apply to other gate structures and/or other types of vehicles.

The car 100 extends along a front-rear direction illustrated as FR-RR, a left-right direction (width direction) illustrated as LF-RT, and an up-down direction illustrated as UP-DOWN. The FR direction is a direction of progression of the car 100 and the other directions are defined with respect to the FR direction, having their normal meaning in the art. Unless stated otherwise, reference in the following to front, rear, left, right, up, down and the like, refer to the above defined directions.

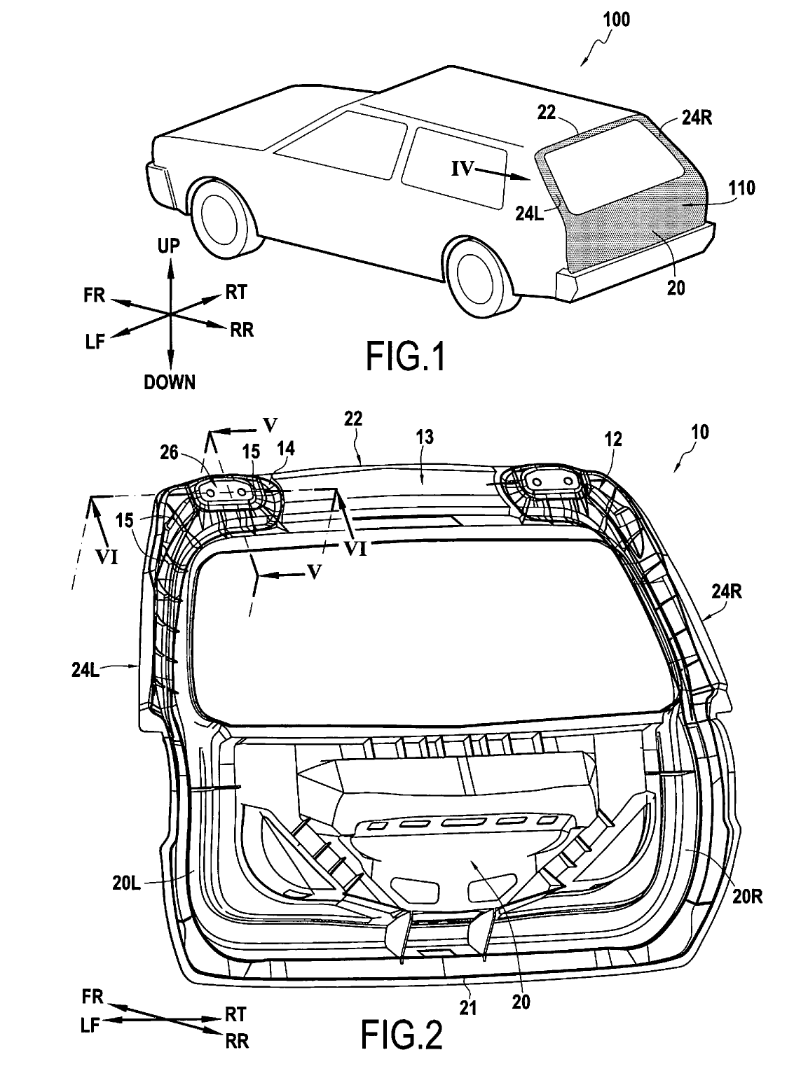

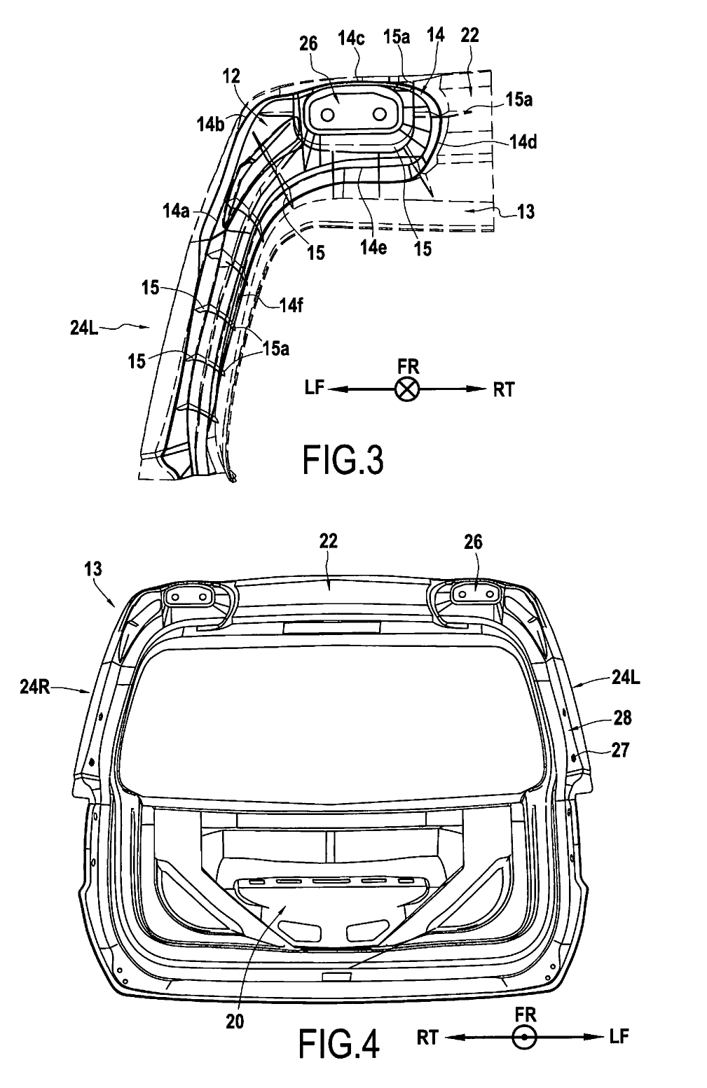

The vehicle tailgate structure 10 is illustrated with more details in FIGS. 2 and 3, which are a perspective rear view of the vehicle tailgate structure 10 and a detail thereof, respectively. The vehicle tailgate structure 10 comprises a first panel portion 12, outlined in bold, and a second panel portion 13 which is represented in thin lines in FIG. 2 and dash lines in FIG. 3.

The first panel portion 12 may comprise a continuous fiber-reinforced material, which, as explained earlier, comprises continuous fibers embedded in a matrix. The matrix may be made of thermoplastic material, such as polypropylene (PP). The fibers may be glass fibers (GF). Continuous fibers may have a length greater than 20 mm (millimeters). The fibers may be arranged within the composite material in a quasi-isotropic way, i.e., as explained earlier, the fibers may be oriented in at least three directions, preferably substantially regularly distributed. The continuous fiber-reinforced material may be obtained from an organo-sheet.

The second panel portion 13 is overmolded onto the first panel portion 12. As will be explained below in greater details, the overmolding may be achieved as follows: the first panel portion 12 may be inserted in an injection mold and material for constituting the second panel portion 13 is injected in the mold, onto the first panel portion 12. If need be, the first panel portion 12 may be pre-heated before its insertion into the mold, so as to soften and to become deformable. The pre-heating of the first panel portion 12 may be carried out to adapt the shape of the first panel portion 12 to the shape of the mold.

The second panel portion 13 may be made of any material that is compatible with overmolding, in particular with injection molding. For instance, the second panel portion 13 may comprise a composite material, e.g. a matrix of PP reinforced with long glass fibers. As explained previously, so-called long fibers are known per se in the art and known to be shorter than continuous fibers. The size of long fibers may range from 0.2 to 20 mm. The composite material may comprise about 40 wt % of fibers. The fibers of the second panel portion 13 may also be short fibers, e.g. fibers shorter than 0.2 mm. Besides, instead of glass, the fibers may be made of other material such as carbon or aramid. The second panel portion 13 may also not comprise any fiber.

The first panel portion 12 and/or the second panel portion 13 may have a constant thickness, e.g. about two millimeters. The first panel portion 12 and/or the second panel portion 13 may conversely have a varying thickness, e.g. for locally increased stiffness.

Together, the first panel portion 12 and the second panel portion 13 form a body portion 20, a transverse beam 22 and side beams 24L, 24R. The side beams 24L, 24R connect the transverse beam 22 to the body portion 20. Together, the body portion 20, the transverse beam 22 and the side beams 24L, 24R may surround a tailgate window carrying portion.

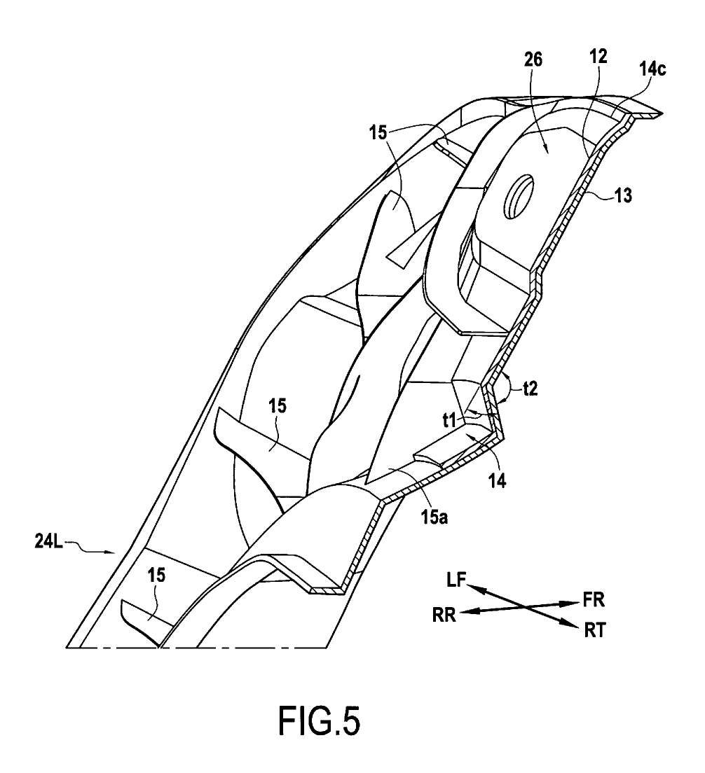

As previously explained and as illustrated in FIGS. 2 and 3, the transverse beam 22 comprises a hinge attachment portion 26 configured to receive a hinge attachment part. The hinge attachment part is configured to fasten the vehicle tailgate structure 10 to the rest of the car 100, e.g. to a car body. The hinge attachment part may be a separate part or may be formed directly in the first panel portion 12. As can be seen in FIG. 2, in this embodiment, the hinge attachment portion 26 extends in the first panel portion 12. However, alternatively or additionally, the hinge attachment portion 26 may extend in the second panel portion 13 (see FIG. 4).

In this embodiment, the first panel portion 12 extends from a left hinge attachment portion 26 in the transverse beam 32, downwards along the left beam 24L and a left side 20L of the body portion 20, then further in the left-right direction, e.g. along a bottom portion 21 of the body portion 20, then upwards along a right side 20R of the body portion 20 and along the right beam 24R, up to a right hinge attachment portion 26. Globally, the first panel portion 12 extends at least partially along an edge of the vehicle tailgate structure 10. In this embodiment, the first panel portion 12 is continuous and made of a single piece. However, in other embodiments, the first panel portion 12 may be discontinuous and/or comprise a plurality of pieces or patches connected with one another. Manufacturing the first panel portion 12 out of smaller pieces allows material savings.

In order to achieve a high stiffness of the vehicle tailgate structure, the first panel portion 12 has a bent strip 14 in the transverse beam 22. The bent strip 14 may at least partly surround the hinge attachment portion 26. The bent strip 14 may be provided at least on opposite sides of the hinge attachment portion 26. Besides, the bent strip 14 may extend to at least one of the side beams 24L, 24R.

In the present embodiment, as shown particularly in FIG. 3, the bead 14 comprises a first side bent strip portion 14a extending in the side beam 24L, an outer bent strip portion 14b extending on the left side of the hinge attachment portion 26 (i.e. on the outer side in the vehicle width direction LF-RT), an upper bent strip portion 14c extending above the hinge attachment portion 26, an inner bent strip portion 14d extending on the right side of the hinge attachment portion 26 (i.e. on the inner side in the vehicle width direction LF-RT), a lower bent strip portion 14e extending below the hinge attachment portion 26, and a second side bent strip portion 14f extending in the side beam 24L, on the right side of the first side bent strip portion 14a. The bent strip 14 may comprise all or part of these bent strip portions 14a-14f. The bent strip portions 14a-14f may each be continuous and may continuously extend from one to another, e.g. in the above-described order. The outer bent strip portion 14b, the upper bent strip portion 14c, the inner bent strip portion 14d and the lower bent strip portion 14e are portions of the first panel portion 12 located at the transverse beam 22.

As shown in FIGS. 2 and 3, the vehicle tailgate structure 10 may further comprise at least one stiffening rib 15 overmolded on the first panel portion 12, e.g. on a side of the first panel portion 12 opposite the second panel portion 13. Here, the vehicle tailgate structure 10 comprises a plurality of stiffening ribs 15. FIG. 2 shows that the stiffening ribs 15 are overmolded on the rear side of the first panel portion 12, while the second panel portion 13 is overmolded on the front side of the first panel portion 12.

At least one of the stiffening ribs 15 may extend substantially across the first panel portion 12. Alternatively or additionally, at least one of the stiffening ribs 15 may extend around the hinge attachment portion.

In this embodiment, as illustrated more precisely in FIG. 3, some, preferably most of, preferably each of the at least one stiffening rib 15 has at least one end 15a thereof directly connected to the second panel portion 13. Thus, a plurality of flow paths is established for molding the stiffening ribs 15. As explained earlier, the overmolding process is thereby improved.

Turning to FIG. 4, it can be seen that in this embodiment, the second panel portion 13 completely covers a side, e.g. a front side, of the first panel portion 12. This ensure mechanical continuity and integrity of the vehicle tailgate structure 10, as the second panel portion 13 fully supports the first panel portion 12, and, as explained previously, eliminates the need for an inner trim to hide the first panel portion 12 from the vehicle inside, as overmolding can already achieve a satisfactory surface quality.

As mentioned earlier, the second panel portion 13 may be overmolded onto the first panel portion 12 by injection molding. To ensure that the first panel portion 12 moves as little as possible during the injection, injection ports or gates may be located opposite the first panel portion 12. Thus, following the molding through one or several injection gates, injection gate marks may be left on the second panel portion 13, in particular on the front side thereof. However, the injection gates may be located so that marks will be left in locations that will be eventually hidden. For instance, the vehicle tailgate structure 10 comprises an actuator attachment portion 28 which is configured to receive an actuator attachment part, the actuator being configured to assist an opening and/or closing operation of the vehicle tailgate 110. In this embodiment, the actuator may be a gas spring configured to urge the vehicle tailgate 110 in the open position.

As can be seen in FIG. 4, the second panel portion comprises an injection gate mark 27 in the actuator attachment portion 28. An injection gate mark could alternatively or additionally be located in the hinge attachment portion 26, which is to be covered by the hinge attachment part.

FIG. 5 is a perspective view showing the cross-section of the vehicle tailgate structure of FIG. 2 along plane V-V. As can be seen in FIG. 5, the bent strip 14 has a bending angle t1 which is less than 90°, preferably less than 80°, preferably less than 70°, preferably less than 60°, with respect to said adjacent portion. That is, the angle t2 between the bent strip 14 and an adjacent portion of the first panel portion 12 (i.e., the angle t2 that is supplementary to the above-mentioned bending angle t1) is not a right angle, and is greater than a right angle. In this embodiment, the bending angle t1 is approximately 45° for most of the bent strip 14. With this provision, it is ensured that the fibers of the first panel portion are not broken due to the angle of the bent strip 14 and remain sound and continuous between the bent strip 14 and said adjacent portion, thereby ensuring a satisfactory transfer of stresses. However, the angle may vary along the extension of the bead 14. For instance, as can be seen in FIG. 5, the upper bent strip portion 14c is slightly flattened, with respect to the other portions of the bent strip 14. Such flattening may be provided for assembly reasons.

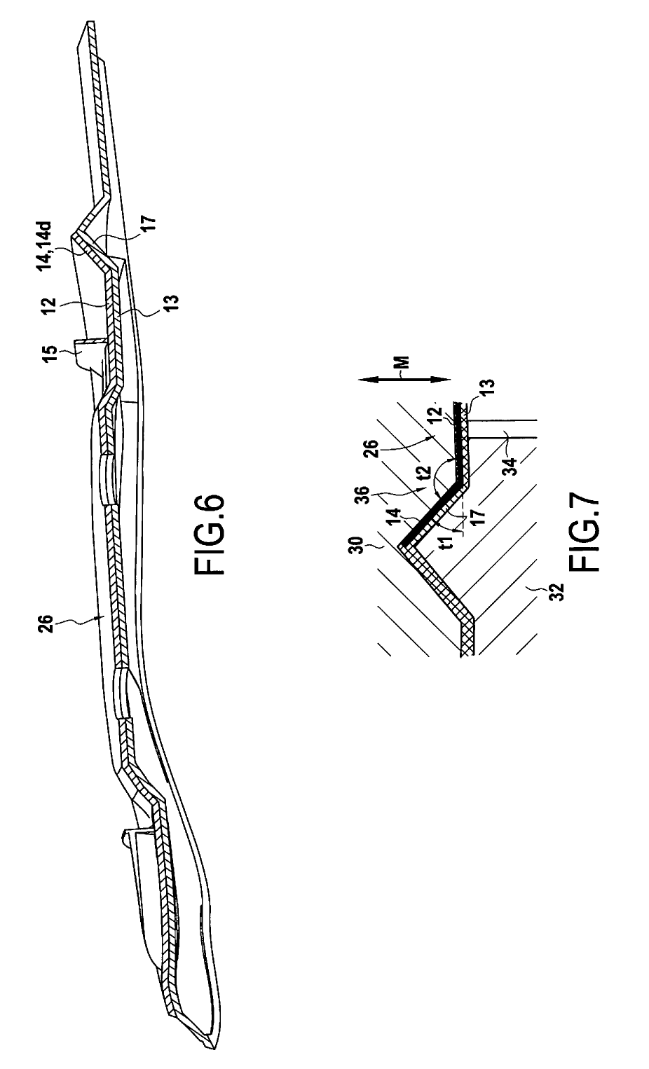

As can be seen in FIG. 6, in this embodiment, the second panel portion 13 has a bead 17 supporting the bent strip 14. The bead 17 is a dent of the second panel portion 13 which may not be required by design constraints, but be provided exclusively to support the bent strip 14. The bead 17 also increases the stiffness of the vehicle tailgate structure 10, all the more so as it is provided close to or in an area of high stresses, namely the transverse beam 22 or even the hinge attachment portion 26. Besides, as illustrated in FIG. 6, the bead 17 is provided on an inner side, in the width direction, of the first panel portion 12; the bead 17 is configured to support the inner bent strip portion 14d. Other portions of the bent strip 14 may be supported by design-constrained corrugations of the second panel portion 13.

In this embodiment, the bead 17 has substantially a V-shaped cross-section. However, other shapes may be contemplated.

Further advantages of the bead 17 will be explained with reference to FIG. 7, which diagrammatically illustrates an embodiment of a method of manufacturing a vehicle tailgate structure such as the one described above. Note that the left-right direction of FIG. 7 is inverted with respect to that of FIG. 6.

As previously indicated, the method of manufacturing comprises providing a mold having a cavity comprising a body portion forming portion for forming a body portion 20, a transverse beam forming portion for forming a transverse beam 22, and side beam forming portions for forming side beams 24L, 24R configured to connect the transverse beam 22 to the body portion 20, wherein the transverse beam forming portion is configured to form a hinge attachment portion 26 configured to receive a hinge attachment part. The mold comprises a first mold portion 30 and a second mold portion 32, defining therebetween said cavity.

The first panel portion 12 is inserted into the cavity, specifically onto the first mold portion 30 as illustrated. A curved portion 36 of the first mold portion 30 is provided so as to form the bent strip 14. As explained previously, the first panel portion 12 may be pre-heated before its insertion into the cavity, so as to be deformable and correctly form the bent strip 14, e.g. against the curved portion 36. As the bending angle t1 of the bent strip 14 is less than 90°, forming the first panel portion 12 is easy.

Then, the first and second mold portions 30, 32 are assembled with each other, e.g. in the tool closing direction M, so as to close the cavity. Material such as thermoplastic resin is injected through the injection gate 34 so as to overmold the second panel portion 13 onto the first panel portion 12. In this case, the injection gate 34 is provided on the second mold portion 32, that is, opposite the wall of the cavity on which the first panel portion 12 has been set up. Thus, during injection, the injection pressure pushes the first panel portion 12 against said wall. Accordingly, the first panel portion 12 is prevented from moving inside the cavity and the shape of the first panel portion 12 is kept more accurate.

Furthermore, due to the bending angle t1 being less than 90°, there is no large undercut that would be filled by the thermoplastic and that would result in an enlarged portion of the second panel portion 13 highly subject to irregular shrinkage. Quite the reverse, as can be seen in FIG. 7, the second panel portion 13, including the bead 17, may have a constant thickness. The quality and strength of the second panel portion 13 is thereby improved.

In addition, as the bending angle t1 is less than 90°, the surface of the bead 17 opposite the bent strip 14 may also be angled by less than 90°, which makes demolding easier.

Although the above description has focused on the left side of the vehicle tailgate structure 10, the right side of the vehicle tailgate structure 10 may have similar and/or symmetric features, as shown in FIGS. 2 and 4.

Although the present invention has been described by referring to specific exemplary embodiments, modifications may be provided to these examples without the departing from the general scope of the invention as defined by the claims. In particular, individual characteristics of the different illustrated/mentioned embodiments may be combined in additional embodiments. Therefore, the description and the drawings should be considered in an illustrative rather than in a restrictive sense.

1. A vehicle tailgate structure comprising a first panel portion comprising a composite material and a second panel portion overmolded onto the first panel portion, the first and second panel portions forming together a body portion, a transverse beam and side beams connecting the transverse beam to the body portion, wherein the transverse beam comprises a hinge attachment portion configured to receive a hinge attachment part, and wherein the first panel portion has a bent strip in the transverse beam, wherein the bent strip is raised with respect to a remaining portion of the first panel portion.

2. The vehicle tailgate structure as claimed in claim 1, wherein the second panel portion has a bead supporting the bent strip.

3. The vehicle tailgate structure as claimed in claim 1, wherein the bent strip is provided at least on opposite sides of the hinge attachment portion.

4. The vehicle tailgate structure as claimed in claim 1, wherein a bending angle of the bent strip is less than 90°.

5. The vehicle tailgate structure as claimed in claim 1, wherein the bent strip extends to at least one of the side beams.

6. The vehicle tailgate structure as claimed in claim 1, wherein the hinge attachment portion extends in the first panel portion.

7. The vehicle tailgate structure as claimed in claim 1, wherein the composite material comprises continuous fibers embedded in a matrix.

8. The vehicle tailgate structure as claimed in claim 7, wherein an arrangement of the continuous fibers is quasi-isotropic.

9. The vehicle tailgate structure as claimed in claim 1, further comprising at least one stiffening rib overmolded on the first panel portion, on a side of the first panel portion opposite the second panel portion.

10. The vehicle tailgate structure as claimed in claim 9, wherein most of the at least one stiffening rib have at least one end thereof directly connected to the second panel portion.

11. The vehicle tailgate structure as claimed in claim 1, wherein the second panel portion completely covers a side of the first panel portion.

12. The vehicle tailgate structure as claimed in claim 1, wherein the second panel portion comprises an injection gate mark in at least one of the hinge attachment portion and an actuator attachment portion.

13. A vehicle tailgate comprising the vehicle tailgate structure as claimed in claim 1.

14. A vehicle comprising the vehicle tailgate structure as claimed in claim 1.

15. A method of manufacturing a vehicle tailgate structure, comprising:
providing a mold having a cavity comprising a body portion forming portion for forming a body portion, a transverse beam forming portion for forming a transverse beam, and side beam forming portions for forming side beams configured to connect the transverse beam to the body portion, wherein the transverse beam forming portion is configured to form a hinge attachment portion configured to receive a hinge attachment part;
inserting a first panel portion, comprising a composite material, into the cavity;
forming a bent strip in the first panel portion, wherein the bent strip is raised with respect to a remaining portion of the first panel portion;
overmolding a second panel portion onto the first panel portion.

16. The method of manufacturing as claimed in claim 15, wherein the mold comprises at least one injection gate opening out in a portion of the cavity configured to form a hinge attachment portion or an actuator attachment portion.

17. The method of manufacturing as claimed in claim 15, wherein the inserting comprises setting up the first panel portion on a wall of the cavity opposite an injection gate of the mold.

18. The vehicle tailgate structure as claimed in claim 1, wherein a bending angle of the bent strip is less than 60°.
